(19) United States
(12) Patent Application Publication
(10) Pub. No.: US 2009/0276554 A1
(43) Pub. Date: Nov. 5, 2009

(54) COMPUTER SYSTEM AND DATA-TRANSMISSION CONTROL METHOD

(75) Inventor: Yu-Chen Lee, Taipei (TW)

Correspondence Address: WPAT, PC, 7225 BEVERLY ST., ANNANDALE, VA, 22003, US

(73) Assignee: ASUSTEK COMPUTER INC., Taipei (TW)

(21) Appl. No.: 12/426,654

(22) Filed: Apr. 20, 2009

(30) Foreign Application Priority Data
Apr. 30, 2008 (TW) 097115932

(51) Int. Cl. G06F 13/00

(52) U.S. Cl. 710/301

(57) ABSTRACT

A computer system includes a bridge having a transmitting channel and a controller, wherein the transmitting channel is controlled by the controller; a first slot disposed therein a first pin connected to the controller; and a second slot disposed therein a second pin connected to the controller. The controller is enabled through the first pin and the second pin while a first device is plugged in the first slot and a second device is plugged in the second slot. A data is transmitted to the first and second devices through the transmitting channel. Alternatively, the data is directly transmitted to the first device if only the first slot is plugged with the first device.

### FIELD OF THE INVENTION

The present invention relates to a computer system, and more particularly to a computer system having a PCI-E (Peripheral Component Interconnect Express) bridge. The present invention also relates to a data-transmission control method of a computer system for use with a bridge.

### BACKGROUND OF THE INVENTION

FIG. 1 is a block diagram depicting a chipset structure in a computer system (Intel P35 platform system). The chipset structure comprises a CPU (Central Processing Unit) 11, a north-bridge chip 13, and a south-bridge chip 15. The north-bridge chip 13 is of a P35 structure; the south-bridge chip 15 is of a ICH9 structure; and the north-bridge chip 13 and the south-bridge chip 15 are combined as a chipset.

The north-bridge chip 13 is used for controlling the data transmitted between the high-speed devices in the computer system, and the high-speed devices in the computer system include the CPU 11, a memory 17, and a graphics chip 19. Basically, the north-bridge chip 13 functions like a data-transmitting center comprising a plurality of channels. These channels are connected to the CPU 11, the memory 17, the graphic chip 19, and the south-bridge chip 15. Through the north-bridge chip 13, data can be transmitted between the CPU 11 and all other high-speed devices in the computer system.

The graphics chip 19 is classified to a high-speed device in recent years. Because the graphics chip 19 has to process more and more data, an AGP (Accelerated Graphics Port) is introduced between the graphics chip 19 and the north-bridge chip 13 as the north-bridge chip 13 has no corresponding buses for transmitting the large amount of data to the graphics chip 19. Because AGP is a one-to-one bus, only one graphics card, or graphics chip, can be plugged in the AGP. Due to the restriction inherent in the AGP, the PCI-E, for integrating the PCI and the AGP, is introduced and regarded as another bus standard.

The main advantage of the PCI-E is high data-transmitting speed. The data-transmitting speed of the PCI-E is now up to 10 GB/s, and still increasing. The PCI-E has several specifications (from PCI-E 1X to PCI-E 16X), and theses different specifications based on different data-transmitting speeds are suitable for devices from low speed to high speed. The main distinctions between the PCI-E and AGP are in that the total lanes of the PCI-E X16 constitute a wider bandwidth and exhibit a higher data-transmitting speed than those of the AGP; and moreover, one or more of the lanes in the PCI-E is designed for duplex transmission, so data can be transmitted in two opposite directions (in and out) at the same time, but in AGP, data is restricted to be transmitted in one direction (alternatively in or out) at the same time. These advantages result in the increase of data-transmitting speed in PCI-E up to 2×4 Gb/s=8 Gb/s while the data-transmitting speed in AGP is only up to 2 Gb/s.

The duplex-transmission lanes in the PCI-E can be combined to several paths, and each path can have a flexible number of duplex-transmission lanes, where the bandwidth of each duplex-transmission lane is 500 MB. In other words, even the total number of duplex-transmission lanes supported by the north-bridge chip is fixed, the total number of paths is variable. For example, the NVIDIA MCP55 can support PCI-E X28 (28 lanes), and these 28 lanes can be allocated to one single graphics card (PCI-E X16), and the rest 12 lanes can further be allocated to other slots (X8, X4, or X1). Alternatively, these 28 lanes can be allocated to two graphics cards (PCI-E X8, PCI-E X8), and the rest 12 lanes can be further allocated to other slots (X8, X4, or X1). Since a path in the PCI-E consists of different number of lanes, the north-bridge chip is free from the restriction of plugging with one single graphics card. Advanced Micro Devices, Inc. (AMD) named the technology of supporting multiple graphics cards as “Crossfire”; and NVIDIA Corporation named it as “SLi”.

The dual display technology for more than one graphics card can be implemented in one computer system, and more than one graphics cards in one computer system means better performance when the computer system is dealing with image data. Basically, the dual display technology can be achieved through two methods. The first method is that the two graphics cards take turns to process the image data. For example, the first graphics card deals with the 1st, 3rd, 5th, 7th . . . image frames and the second graphics card deals with the 2nd, 4th, 6th, 8th . . . image frames, and these processed image frames are then combined into a one-second picture. In other words, if a one-second picture contains 60 image frames, the first graphics card processes 30 of the 60 image frames (odd number ones) and the second graphics card processes the other 30 images (even number ones), and then the two groups of 30 image frames are combined into the one-second picture. Since each graphics card only needs to deal with a half number of image frames (30 image frames) in a specified duration, the load of each graphics card is decreasing so as to increase the performance. The second method of implementing the dual display technology is to divide each image into two parts first, and the two half parts of the image are respectively processed by the first and the second graphics cards. For example, if one image is divided into an upper part and a lower part, then the first graphics card may deal with the upper part of the image and the second graphics card may deal with the lower part of the image. The processed upper-part image and the processed lower-part image are then combined to one complete image.

By way of the dual display technology, the north-bridge chip is capable of plugging with more than one graphics cards in a computer system. When more than one graphics cards are plugged, a PCI-E Bridge is necessary to be introduced to facilitate the north-bridge chip simultaneously communicate with these graphics cards. It is understood the north-bridge chip can also communicate with the graphics card through the PCI-E bridge if the graphics card is the only device plugged in.

FIG. 2 is a diagram depicting a computer system having a north-bridge chip connected to two PCI-E slots through a Q Switch and a PCI-E Bridge. The computer system comprises: a north-bridge chip 31, a PCI-E bridge 33, a Q switch (Q-SW) 35, a first PCI-E slot 37, and a second PCI-E slot 39.

If both the first PCI-E slot 37 and the second PCI-E slot 39 are plugged with a graphics card, the Q Switch 35 is designed to be switched to the PCI-E bridge 33. In other words, the data from the north-bridge chip 31 is first transmitted to the Q Switch 35, and then transmitted to the first PCI-E slot 37 and the second PCI-E slot 39 through a transmitting channel 34 provided by the PCI-E Bridge 33, where the transmitting channel 34 is a first-in-first-out (FIFO) queue. Alternatively, if only one graphics card is plugged in (assuming the first PCI-E slot 37 is plugged with a graphics card and the second PCI-E slot 39 is not plugged with a graphics card), the Q Switch 35 is designed to be switched to the first PCI-E slot 37. In other words, the data from the north-bridge chip 31 is directly transmitted to the first PCI-E slot 37 through the Q Switch 35 without passing via the PCI-E Bridge 33.

Obviously, the conventional PCI-E bridge 33 is on duty only when both the two graphics cars are plugged to the first PCI-E slot 37 and the second PCI-E slot 39. Once only one graphics card is plugged to the PCI-E slot, the additional Q Switch 35 need be implemented in the system. However, the addition of the Q Switch 35 increases cost and occupies area in the motherboard.

### SUMMARY OF THE INVENTION

Therefore, the present invention relates to a computer system using a PCI-E bridge for controlling the data transmitting.

The invention provides a computer system, comprising: a bridge comprising a transmitting channel and a controller, wherein the transmitting channel is controlled by the controller; a first slot disposed therein a first pin connected to the controller; and a second slot disposed therein a second pin connected to the controller; wherein the controller is enabled through the first pin and the second pin while a first device is plugged in the first slot and a second device is plugged in the second slot, and a data is transmitted to the first and second devices through the transmitting channel; or, the data is directly transmitted to the first device if only the first slot is plugged with the first device.

Furthermore, the invention provides a data-transmission control method of a computer system for use with a bridge connected with a first slot and a second slot. The method includes steps of: determining a plugging state of a first device into the first slot and a plugging state of a second device into the second slot; transmitting a data to both the first and the second slots through a transmitting channel in the bridge if the first slot is plugged with the first device and the second slot is plugged with the second device; and directly transmitting the data to the first slot without passing through the transmitting channel if only the first slot is plugged with the first device.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a block diagram illustrating a chipset system in a computer system (Intel P35 platform system);

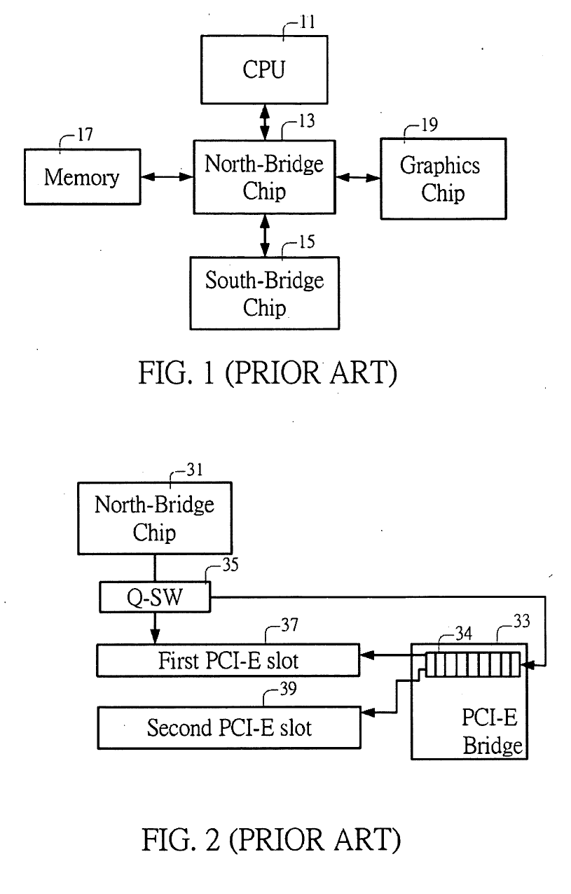

FIG. 2 schematically illustrates a north-bridge chip connecting to a PCI-E slot through a Q switch, or, connecting to two PCI-E slots respectively through a Q switch and a PCI-E bridge; and

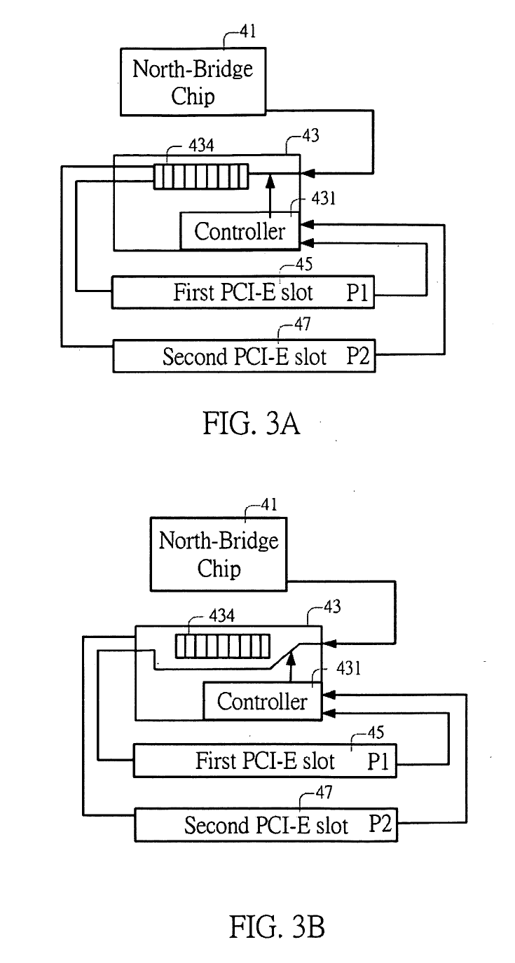

FIGS. 3A, 3B, and 3C schematically illustrate a north-bridge chip connecting to two PCI-E slots through a PCI-E slot based on three different conditions according to an embodiment of the present invention.

### DETAILED DESCRIPTION OF PREFERRED EMBODIMENTS

A PCI-E bridge is capable of operating between a normal-operation mode and a pass-through mode according to the present invention. When two graphics cards are detected, the PCI-E bridge of the present invention is determined to operate in the normal-operation mode, and the data from a north-bride chip is transmitted to both a first PCI-E slot and a second PCI-E slot through a transmitting channel in the PCI-E bridge. Alternatively, if only one graphics card is detected, the PCI-E bridge is determined to operate in the pass-through mode, and the data from the north-bridge chip is directly transmitted to the PCI-E slot plugged with the graphics card without passing via the transmitting channel in the PCI-E bridge. It is understood that the present invention is not limited in the application to a north-bridge chip, all other devices in the computer system, such as a south-bridge chip or a CPU, can also adopt the method in a similar manner.

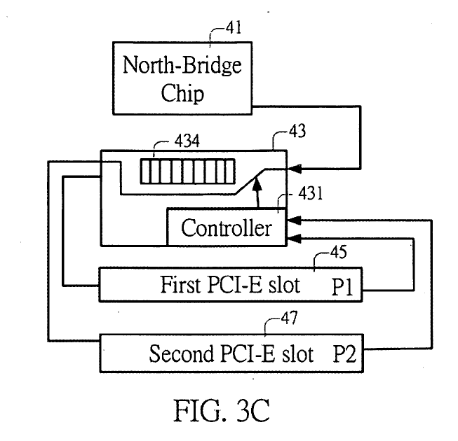

FIGS. 3A, 3B, and 3C are diagrams illustrating operations of a computer system having a north-bridge chip connected to two PCI-E slots through a PCI-E Bridge based on three device-plugging conditions. The computer system includes: a north-bridge chip 41, a PCI-E bridge 43, a first PCI-E slot 45, and a second PCI-E slot 47. The PCI-E Bridge 43 further includes a controller 431 and a transmitting channel 434, wherein the transmitting channel 434 is, for example, a first-in-first-out (FIFO) queue. The controller 431 is used for controlling the PCI-E bridge 43 to be operated either in the normal-operation mode or the pass-through mode by detecting plugging states of the graphics cards in the first PCI-E slot 45 and the second PCI-E slot 47, i.e. whether there is any graphics card plugged into any of the slots or not.

The controller 431 switches the PCI-E bridge 43 to the normal-operation mode if both the first PCI-E slot 45 and the second PCI-E slot 47 are plugged with graphics cards. When the PCI-E bridge 43 is operated in the normal-operation mode, the data from the north-bridge chip 41 is transmitted to both the first PCI-E slot 45 and second PCI-E slot 47 through the transmitting channel 434. On the other hand, the controller 431 switches the PCI-E bridge 43 to the pass-through mode if only one of the first PCI-E slot 45 or the second PCI-E slot 47 is plugged with a graphics card. When the PCI-E bridge 43 is operated in the pass-through mode, the data from the north-bridge chip 41 is directly transmitted to the PCI-E slot having the graphics card without passing through the transmitting channel 434.

In the embodiment of the present invention, each of the first PCI-E slot 45 and the second PCI-E slot 47 has a specific pin, which is named present pin, for detecting the existence of the graphics card. The present pin is pulled up to a high level if the PCI-E slot has no graphics card plugged therein, and otherwise, the present pin is pulled down to a low level if the PCI-E slot has a graphics card plugged therein. For example, if a graphics card is plugged in the first PCI-E slot 45, the present pin (P1) of the first PCI-E slot 45 is at the low level. If the second PCI-E slot 47 is not plugged with a graphics card, the present pin (P2) of the second PCI-E slot 47 is at the high level. By detecting the levels of the present pins, the controller 431 is aware of the plugging states of the first PCI-E slot 45 and second PCI-E slot 47.

FIG. 3A is a diagram showing a computer system having two graphics cards plugged in the slots. After the controller 431 is aware of the fact that both the first PCI-E slot 45 and the second PCI-E slot 47 are plugged with graphics cards by detecting the present pins P1 and P2, the controller 431 controls the PCI-E bridge 43 to be operated in the normal-operation mode. The PCI-E bridge 43, operated in the normal-operation mode, has functions exactly the same as a conventional PCI-E bridge. In other words, the normal-operation-mode PCI-E bridge 43 will provide the transmitting channel 434 for the data from the north-bridge chip 41 to be transmitted to the first PCI-E slot 45 and the second PCI-E slot 47 therevia.

FIG. 3B is a diagram showing a computer system having only one graphics card plugged in the first PCI-E slot 45. After the controller 431 is aware of the fact that only the first PCI-E slot 45 is plugged with a graphics card by detecting the present pins P1 and P2, the controller 431 controls the PCI-E bridge 43 to be operated in the pass-through mode. The normal-operation-mode PCI-E bridge 43 directly transmits the data from the north-bridge chip 41 to the first PCI-E slot 45 without passing via the transmitting channel 434. Therefore, the latency resulting from passing through the transmitting channel 434 can be avoided so as to enhance performance.

FIG. 3C is a diagram showing a computer system having only one graphics card plugged in the second PCI-E slot 47. After the controller 431 is aware of the fact that only the second PCI-E slot 47 is plugged with a graphics card by detecting the present pins P1 and P2, the controller 431 controls the PCI-E bridge 43 to be operated in the pass-through mode. The normal-operation-mode PCI-E bridge 43 directly transmits the data from the north-bridge chip 41 to the second PCI-E slot 47 without passing via the transmitting channel 434. Therefore, the latency resulting from passing through the transmitting channel 434 can be avoided so as to enhance performance.

With the introduction of the PCI-E bridge capable of being optionally operated in the normal-operation mode or the pass-through mode, the data from the north-bridge chip can be directly transmitted to the PCI-E slot without passing via the transmitting channel in the PCI-E bridge if a valid plugging state of only one graphics card is detected. Thus the latency resulting from passing through the transmitting channel can be avoided. Moreover, with the introduction of the PCI-E bridge, the Q switch is no longer required as the data from the north-bridge chip is always transmitted to the PCI-E slot through the PCI-E bridge. Thus the cost and area in the motherboard required by the Q switch can be avoided.

Moreover, it is understood the present invention is not limited to the application to graphics card. Other PCI-E devices (e.g., Raid device) can also be used with the PCI-E bridge according to the present invention to achieve similar objects.

Moreover, it is understood the present invention is not limited to the application to two graphics cards. More than two graphics cards can be used with the PCI-E bridge according to the present invention to achieve similar objects.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A computer system, comprising:
a bridge comprising a transmitting channel and a controller, wherein the transmitting channel is controlled by the controller;
a first slot disposed therein a first pin connected to the controller; and
a second slot disposed therein a second pin connected to the controller;
wherein the controller is enabled through the first pin and the second pin while a first device is plugged in the first slot and a second device is plugged in the second slot, and a data is transmitted to the first and second devices through the transmitting channel; or the data is directly transmitted to the first device if only the first slot is plugged with the first device.

2. The computer system according to claim 1 wherein each of the first device and the second device is either a graphics card or a Raid device.

3. The computer system according to claim 1 further comprising a chipset from which the data is transmitted to the bridge.

4. The computer system according to claim 3 wherein the chipset is a north-bridge chip.

5. The computer system according to claim 1 wherein the bridge is a first-in-first-out queue.

6. The computer system according to claim 1 further comprising a central processing unit from which the data is transmitted to the bridge.

7. A data-transmission control method of a computer system for use with a bridge connected with a first slot and a second slot, comprising steps of:
determining a plugging state of a first device into the first slot and a plugging state of a second device into the second slot;
transmitting a data to both the first and the second slots through a transmitting channel included in the bridge if the first slot is plugged with the first device and the second slot is plugged with the second device; and
directly transmitting the data to the first slot without passing through the transmitting channel if only the first slot is plugged with the first device.

8. The method according to claim 7 wherein each of the first device and the second device is either a graphics card or a Raid device.

9. The method according to claim 7 wherein the data is transmitted to the bridge from a chipset.

10. The method according to claim 9 wherein the chipset is a north-bridge chip.

11. The method according to claim 7 wherein the bridge is a first-in-first-out queue.

12. The method according to claim 7 wherein the data is transmitted to the bridge from a central processing unit.
